(19) United States
(12) Patent Application Publication
(10) Pub. No.: US 2021/0381732 A1
(43) Pub. Date: Dec. 9, 2021

(54) THERMAL SENSING BULB CONTAINING A BALLAST MATERIAL FOR AN EXPANSION VALVE

(71) Applicant: Parker-Hannifin Corporation, Cleveland, OH (US)

(72) Inventors: Debasis BANERJEE, Ellisville, MO (US); Richard C. LARASH, Pacific, MO (US); Matthew SPAUNHORST, Washington, MO (US); Adam P. HUGHES, O'Fallon, MO (US)

(21) Appl. No.: 17/287,775

(22) PCT Filed: Jan. 3, 2020
(86) PCT No.: PCT/US2020/012105

§ 371 Date: Apr. 22, 2021

Related U.S. Application Data
(60) Provisional application No. 62/788,429, filed on Jan. 4, 2019.

(51) Int. Cl. F25B 41/33; C01F 7/02

(52) U.S. Cl. CPC F25B 41/33; C01F 7/02; C01P 2004/60; F25B 2600/2513; C01P 2004/02; F25B 2341/0682; F25B 2500/15; C01P 2006/12

(57) ABSTRACT

A thermal sensing bulb (102) for an expansion valve (104) in a refrigerant system, the bulb containing a ballast material (108), the ballast material including alumina. More particularly, the ballast material (108) includes alpha alumina, which may be in the form of a plurality of discrete particles having a desired surface area, particle size, and/or particle size distribution.

### RELATED APPLICATIONS

This application claims the benefit of U.S. Provisional Application No. 62/788,429 filed Jan. 4, 2019, which is hereby incorporated herein by reference in its entirety.

### FIELD OF INVENTION

The present invention relates generally to ballast material for a thermostatic expansion valve as employed in refrigerant systems, particularly of the compressor-condenser-evaporator type. More particularly, the present invention relates to a ballast material including alumina which may have a particular surface area for use in such thermostatic expansion valve.

### BACKGROUND

A refrigerant system typically includes a thermostatic expansion valve including a thermal sensing bulb, which may operate as a refrigeration and air conditioning throttling device that controls the amount of liquid refrigerant injected into the system's evaporator. The thermal sensing bulb is located in a position selected by manufacturers and/or contractors to provide feedback information about the operation of the system, which is used by the thermal expansion valve to make changes in refrigerant flow to effect changes in the thermal condition of the system. In general, the thermal sensing bulb communicates with the thermostatic expansion valve by means of a working fluid which expands or contracts with temperature changes experienced by the thermal sensing bulb and thereby affects operation of the thermostatic expansion valve.

A long-standing problem with thermostatic expansion valves (TEVs) in traditional refrigerant systems is a “hunting” phenomenon, which is the excessive cycling/oscillation of thermostatic control valves in response to transient changes in the refrigerant system. The hunting phenomenon occurs when the working fluid is, in effect, overly sensitive to outside parameters, resulting in rapidly fluctuating changes being communicated to the thermostatic expansion valve. Excessive hunting can reduce capacity and efficiency of the system, wasting energy.

Conventionally, solid state, heat-resistant materials in block or beaded form (commonly known as ballast) are generally used inside the thermal sensing bulb to reduce the sensitivity of the working fluid while maintaining adequate thermal control. The ballast typically works by means of adsorbing/desorbing refrigerant in the bulb with changing temperature, in which the rate of adsorption-desorption of refrigerant in the ballast material determines the ‘sensing’ ability of the valve itself, as determined by a time constant. In this manner, the ballast controls the rate of pressure modulation within the bulb, stabilizing the bulb pressure by dampening the rate of temperature change to the bulb charge compared to the rate of temperature change of the suction line of the system. This stabilization allows the thermal expansion valve to operate more efficiently and better protects the compressor in the refrigerant system.

Ballasts are typically block shaped and made of earth-abundant materials that fall under the broad classification of clay minerals. While so far these materials have provided sufficient and reliable performance, they lack tunability in terms of surface area and pore size. These latter two properties determine the dampening behavior of the working fluid in the ballast material. Accordingly, there is a need for a ballast material having good manufacturing processability, hydrophobicity, heat-resistance, refrigerant compatibility, and suitable adsorption-desorption properties.

### SUMMARY OF INVENTION

The present invention provides an improved thermal sensing bulb for an expansion valve that contains a ballast material including alumina. The alumina ballast material may be in the form of a plurality of discrete particles. The alumina ballast material may have a desired surface area, pore size, particle size, particle shape, and/or particle size distribution for providing good manufacturing processability, hydrophobicity, heat-resistance, refrigerant compatibility, and desirable adsorption-desorption properties.

In exemplary embodiments, the majority of the ballast material in the thermal sensing bulb may include alpha alumina. The alpha alumina is a high-strength and high-hardness ceramic material, which can resist fracture and prevent formation of dust. The alpha alumina also exhibits high heat resistance and high thermal conductivity, which enables improved performance of the thermal sensing bulb. The surface area of the alpha alumina can also be tunable depending on the calcination temperature that can alter the adsorption-desorption properties. In addition, the alpha alumina has high chemical resistance, which enables compatibility with a wide range of refrigerants.

The alpha alumina also provides the ability to control surface area and/or pore size through suitable processing techniques. By controlling the surface area of the alpha alumina based ballast material, the dampening effect can be controlled by means of controlling the extent of refrigerant adsorption in the material. For example, the greater the surface area of the alpha alumina ballast material, the greater the adsorption of the refrigerant, and hence greater dampening; and vice versa. In addition, controlling the surface area of the alpha alumina may make it less prone to moisture adsorption, which may lead to improved manufacturability and improved operation of the thermostatic expansion valve. Other forms of alumina having the desired properties such as surface area, pore size and/or ability to tailor such properties also may be provided, such as the use of theta alumina, for example.

According to one aspect of the invention, a thermal sensing bulb for an expansion valve is provided, the bulb containing a ballast material, the ballast material comprising alumina, such as alpha alumina.

According to another aspect of the invention, a thermal sensing bulb for an expansion valve is provided, the bulb containing a ballast material, the ballast material comprising greater than 50% alumina, such as alpha alumina.

According to another aspect of the invention, a thermal sensing bulb for an expansion valve is provided, the bulb containing a ballast material, the ballast material including alumina having a specific surface area in the range of 1-60 m²/g.

According to another aspect of the invention, a refrigerant system is provided including a thermostatic expansion valve, the expansion valve including a thermal sensing bulb, the thermal sensing bulb comprising a working fluid, the working fluid sealed inside the thermal sensing bulb and in operative communication with the expansion valve; and a ballast in the thermal sensing bulb, the ballast including an alumina material, such as alpha alumina.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a cross-sectional view of an exemplary thermostatic expansion valve including a thermal sensing bulb and a ballast material including alumina in accordance with an embodiment of the present invention.

FIG. 2 is a photomicrograph of alpha alumina granules that may be utilized as ballast material in the thermal sensing bulb.

FIG. 3 is a photomicrograph of alpha alumina beads that may be utilized as ballast material in the thermal sensing bulb.

FIG. 4 is a chart of pressure versus temperature showing comparative experimental test data of different ballast materials.

### DETAILED DESCRIPTION

According to an aspect of the present disclosure, a refrigerant system is provided including a thermostatic expansion valve, the expansion valve including a thermal sensing bulb, the thermal sensing bulb comprising a working fluid, the working fluid sealed inside the thermal sensing bulb and in operative communication with the expansion valve; and a ballast in the thermal sensing bulb, the ballast including an alumina material.

The refrigerant system may be a refrigeration system, such as of the compressor-condenser-evaporator type. In such a system, the thermostatic expansion valve and the thermal sensing bulb operate as a throttling device for controlling the amount of the working fluid (e.g., refrigerant in gaseous and/or liquid form) injected into the system's evaporator based on the evaporator outlet temperature and pressure. The thermal sensing bulb is located in a position of the system that is selected to provide feedback information about the thermal condition of the refrigerant system, which is used by the thermal expansion valve to make changes in working fluid flow to effect changes in the thermal condition of the system. Generally, the thermal sensing bulb communicates with the thermostatic expansion valve via the working fluid which expands or contracts with temperature changes experienced by the thermal sensing bulb and thereby affects operation of the thermostatic expansion valve. The ballast material contained in the thermal sensing bulb is configured to adsorb/desorb the working fluid in the bulb with changing temperature, in which the rate of adsorption-desorption of the working fluid in the ballast material determines the ‘sensing’ ability of the valve itself. This enables the ballast material to dampen the rate of expansion within the bulb, thereby attenuating rapid changes in the working fluid due to transient changes in the thermal condition of the system.

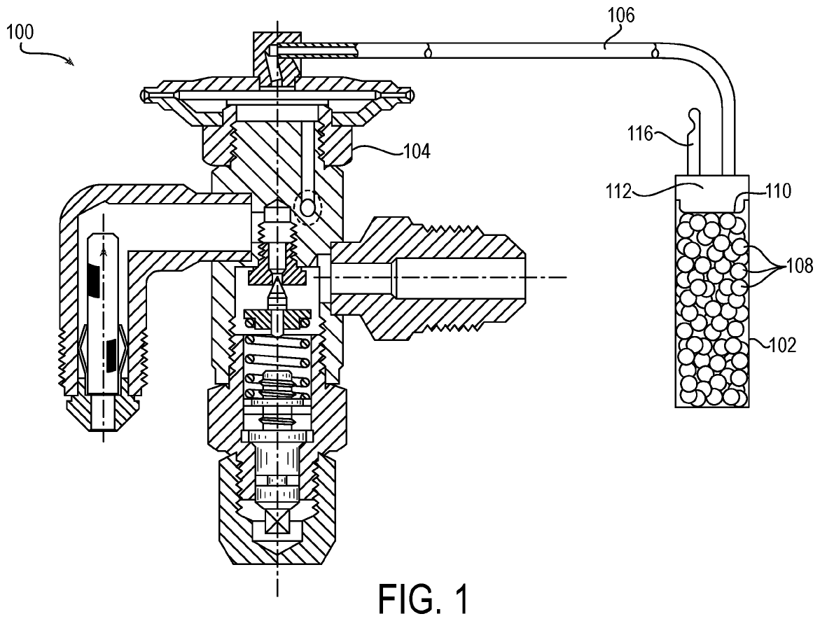

FIG. 1 shows a cross-sectional view of an exemplary thermostatic expansion valve 100 including an exemplary thermal sensing bulb 102 that may be used in the exemplary refrigerant system. The thermostatic expansion valve 100 includes an exemplary valve body 104, the thermal sensing bulb 102, and a channel or tube 106, also referred to as a capillary tube, operatively connecting the valve body 104 to the thermal sensing bulb 102. As shown, the thermal sensing bulb 102 contains a ballast material 108 which includes alumina.

In exemplary embodiments, the alumina used in the ballast material is alpha (α) alumina (also referred to as aluminum oxide or corundum), which is a chemical compound of aluminum and oxygen with the chemical formula Al₂O₃ having the crystalline polymorphic alpha phase of alumina. In the alpha phase, the oxygen ions in the alumina crystal lattice form a nearly hexagonal close-packed structure, with the aluminum ions filling two-thirds of the octahedral interstices. Each Al³⁺ center is octahedrally coordinated. In terms of its crystallography, alpha alumina adopts a trigonal Bravais lattice with a space group of R-3c (number 167 in the International Tables). The primitive cell contains two formula units of aluminum oxide. In exemplary embodiments, the alpha alumina may be formed through the Bayer process, which is well known in the art, although other suitable processes may be used to form alpha alumina.

In exemplary embodiments, the ballast material 108 includes a plurality of discrete particles having alumina, such as alpha alumina. In the illustrated embodiment, the particles (also referred to with reference numeral 108 for clarity) are retained in the thermal sensing bulb 102 by a screen or similar device 110. While this is illustrated, other means known in the art may be used for retaining the particles 108 in the bulb 102. The exact number or quantity of the particles 108 placed in the bulb may be suitably determined by the person of ordinary skill in the art based on the particular design of the thermal sensing bulb 102 and the thermal expansion valve with which it is used.

The particles 108 in the bulb 102 define an inter-particle space surrounding the particles. Generally, a head space 112 is defined above the level of particles retained by the screen 110 in the thermal sensing bulb 102. This inter-particle space and the head space 112 are in fluid communication with an inner volume of the tube 106 and with a working space in the expansion valve 100.

The bulb 102 may include a charge tube 116. A working fluid (e.g., refrigerant such as a fluorocarbon and/or a boost gas) is placed into the inter-particle space, the head space 112, and the working space in the expansion valve 100 by, for example, using the charge tube 116 to introduce the working fluid and thereafter sealing the charge tube 116 to provide a closed system for the working fluid. Other methods as may be known in the art for introducing the working fluid into the thermal sensing bulb may be used.

Suitable working fluids include any material known for such use. These materials include, in the prior art, ammonia and various CFCs, and today include many known replacements for the environmentally undesirable CFCs and HCFCs, including, e.g., R410A and R125. Suitable working fluids for the thermal sensing bulb include the standard refrigerants and gases such as carbon dioxide, propane, R134 and any of the many known HFCs, HCFCs and HFOs such as R410a.

The working fluid in the thermal sensing bulb may have properties substantially similar to the properties of the primary refrigerant working fluid. A suitable working fluid may be selected by the person of ordinary skill in the art, depending on the particular system with which the thermostatic expansion valve is used. The working fluid may be the same as or different from the refrigerant used in the refrigerant system.

In operation, the working fluid transmits temperature change information in the form of pressure changes in the working fluid from the thermal sensing bulb 102 through the interior space of the tube 106 and the working space in the expansion valve 100 to actuate, for example, a diaphragm or other pressure sensor in the thermostatic expansion valve 100. The details of operation of expansion valves such as thermostatic expansion valves are well known in the art and are not be repeated here.

As discussed above, conventional ballasts are generally block shaped and made of earth-abundant materials which fall under the broad classification of clay minerals. While so far these materials have provided sufficient and realizable performance, they lack tunability in terms of surface area and pore size which affect the dampening behavior of working fluid in the ballast material. Also given the chemical nature of the materials, it is often difficult to control variation.

The alumina provided in the ballast material according to the present disclosure provides many improvements over traditional ballast materials. For example, alpha alumina is a readily available, relatively process friendly, and relatively inexpensive material. The alpha alumina is a high-strength and high-hardness ceramic material, which can resist fracture and thus prevent formation of fines that would otherwise alter adsorption characteristics due to contamination of the working fluid. The alpha alumina also exhibits high heat resistance and high thermal conductivity, which enables improved performance of the thermal sensing bulb and/or improved manufacturability of the bulb, especially at elevated temperatures. In addition, the alpha alumina has high chemical resistance, which enables compatibility with a wide range of refrigerants.

The alpha alumina also is easily processable and tailorable to provide a desired surface area, pore size, particle size, particle shape, and/or particle size distribution for providing desired adsorption-desorption properties, which may be selected by one having ordinary skill in the art depending on the particular system with which the thermostatic expansion valve is used. The ability to tailor the properties of the alpha alumina ballast material provides numerous beneficial effects in the thermostatic expansion valve manufacturing process. For example, with such enhanced physiochemical tunability, the ballast material may be specifically tailored for use with different types of expansion valves for different types of refrigerant systems, or with different types of working fluids, thus saving manufacturing time and costs.

By way of example, alpha alumina provides the ability to control surface area and/or pore size of the material through suitable processing techniques as would be understood by those having ordinary skill in the art. By controlling the surface area and/or pore size of the alpha alumina material, the dampening effect of the ballast can be controlled by means of controlling the extent of refrigerant adsorption in the material. For example, the greater the surface area and/or pore size of the alpha alumina ballast material, the greater the adsorption of the refrigerant, and hence greater dampening and longer response time; and vice versa. Accordingly, because the surface area and/or pore size of the alpha alumina ballast material is linked to the performance of the expansion valve by way of how adsorption affects the valve's superheat control and time constant, thermostatic expansion valves with specific types of superheat control and time constant can be manufactured simply by tuning the properties (e.g., surface area and/or pore size) of alpha alumina material ballast material. In addition, controlling the surface area and/or pore size of the alpha alumina may make it less prone to moisture adsorption (e.g. hydrophobic), which may lead to improved manufacturability and improved operation of the thermostatic expansion valve. Other forms of alumina having the desired properties such as surface area, pore size and/or ability to tailor such properties also may be provided, such as the use of theta alumina, for example.

Generally, the greater the amount of alumina (e.g., alpha alumina) material that makes up the ballast, the greater the effect of its performance in terms of manufacturing processability and tailorability, hydrophobicity, heat-resistance, thermal conductivity, strength, refrigerant compatibility, and the like. In exemplary embodiments, the ballast material includes greater than about 50% alumina (e.g., alpha alumina). More particularly, the ballast material may include alumina (e.g., alpha alumina) in the range of about 60-100%; even more particularly in the range of about 80-100% alumina (e.g., alpha alumina). In some preferred embodiments, the ballast material may include alumina (e.g., alpha alumina) in the range of about 90-100%. More particularly, the ballast material may consist essentially of alumina (e.g., alpha alumina), in which about 99% or more of the ballast material is alumina (e.g., alpha alumina), with the remainder including trace impurities, such as Na₂O (e.g., 0.5 wt. % max), Fe₂O₃ (e.g., 0.4 wt. % max), and SiO₂ (e.g., 0.4 wt. % max).

As discussed above, the ballast material may include a plurality of discrete particles having alumina, such as alpha alumina. Providing such a plurality of particles allows the manufacturer of the thermal sensing bulb to provide a much improved uniformity of response to thermal changes, compared to conventional bulbs containing other ballast materials made of other materials and/or having a non-particulate form (such as the single block of material). For example, providing a plurality of particles, particularly smaller particles, may lead to better control of the weight of ballast material in the bulb, thus reducing the variation in bulb response.

In exemplary embodiments, each particle included in the ballast having alumina (e.g., alpha alumina) may include greater than about 50% alumina (e.g., alpha alumina). More particularly, each particle may have about 60-100% alumina (e.g., alpha alumina), more particularly about 80-100% alumina (e.g., alpha alumina), more particularly about 90-100% alumina (e.g., alpha alumina), or more particularly may consist essentially of alumina (e.g., alpha alumina), as those ranges are defined above. In addition, in exemplary embodiments, the plurality of particles having the above-noted range(s) of alumina (e.g., alpha alumina) may constitute greater than about 50% of the ballast material in the bulb, with the remainder (not including working fluid or void space, e.g., inter-particle space and head space) being other material. More particularly, the plurality of particles having alumina (e.g., alpha alumina) may constitute about 60-100% of the ballast material, more particularly about 80-100% alumina (e.g., alpha alumina), more particularly about 90-100% alumina (e.g., alpha alumina), or more particularly may consist essentially of about 99% or more alumina (e.g., alpha alumina).

The ability to control surface area and/or porosity of the alumina material provides the ability to control adsorption of the working fluid and thus dampening characteristics of the ballast material in the bulb. The ability to control surface area and/or porosity of the alumina material also may provide the ability to control moisture adsorption, which otherwise could cause malfunction or failure of the expansion valve.

In exemplary embodiments, the alumina (e.g., alpha alumina) has a specific surface area in the range from about 0.1 m²/g to 60 m²/g. More particularly, the alumina (e.g., alpha alumina) may have a specific surface area in the range from about 5 m²/g to 60 m²/g. The specific surface area range may be the specific surface area of each particle in the ballast having alumina (e.g., alpha alumina), or the average specific area of the plurality of particles, or may be the specific surface of the ballast material having alumina (e.g., alpha alumina) as a whole (e.g., if provided in block form). As would be understood by those having ordinary skill in the art, the surface area of alumina (e.g., alpha alumina) can be controlled through suitable processing techniques, such as chemical, thermal, or physical processing techniques. For example, the surface area of the alumina (e.g., alpha alumina) could be controlled by the method in which the alumina is formed, such as during or after the Bayer process, for example, which generally includes digestion, precipitation, and calcination, and is a well understood process in the art.

In exemplary embodiments, the particles included in the ballast material are substantially uniform in physical characteristic, and a given quantity of the particles exhibits a substantially uniform adsorption characteristic. For example, the particles including alumina may be substantially uniform in one or more of adsorption characteristics, density, surface area, porosity, particle physical size, particle shape and particle weight. This can provide a substantially uniform ballast function in the thermal sensing bulb and thereby provides for improved control of operation of the expansion valve with which the thermal sensing bulb is employed. Such improvement also may have a number of beneficial effects in the thermostatic expansion valve manufacturing process. With more uniformly functioning thermal sensing bulbs, adjustments needed on individual expansion valves to which the thermal sensing bulbs are connected can be reduced, saving manufacturing time and costs, manufacturing tolerances on parts used in the expansion valves can be tightened, thus improving long-term performance and lifetime of the expansion valve, and the overall lifetime of the expansion valves can be improved due to more stable operation with the hunting phenomenon thus further suppressed.

In exemplary embodiments, the overall adsorption characteristic of the alumina ballast material in the thermal sensing bulb is substantially uniform, so that the function of each thermal sensing bulb can be made to be the same. As used herein, a “substantially uniform adsorption characteristic” means that the equilibrium pressure for a constant quantity of refrigerant introduced as the ballast in a thermal sensing bulb at a constant temperature varies by no more than ±10%, more preferably not more than about ±5%, for a given quantity of the particles including alumina. The goal of obtaining a substantially uniform adsorption characteristic is more easily obtained when the particles are substantially uniform in physical characteristics, such as density, surface area, shape and weight. As used herein, “substantially uniform density” when used in reference to the density of the particles including alumina, means that the particles do not differ by more than about ±10% in density, more preferably the particles do not differ by more than about ±5% in density, and still more preferably the particles do not differ by more than about ±2% in density. Similar considerations and tolerances may apply to “substantially similar surface area” and/or “substantially similar weight” of the particles. In addition, a “substantially uniform shape” means that the particles are all generally of the same shape, i.e., substantially spherical, substantially cylindrical, or other shape. Small differences in shape, such as a slightly ovoid spherical shape, or a cylindrical shape that has a slight bulge at the longitudinal center or that has slightly rounded edges at the ends, fall within the definition of substantially uniform shape.

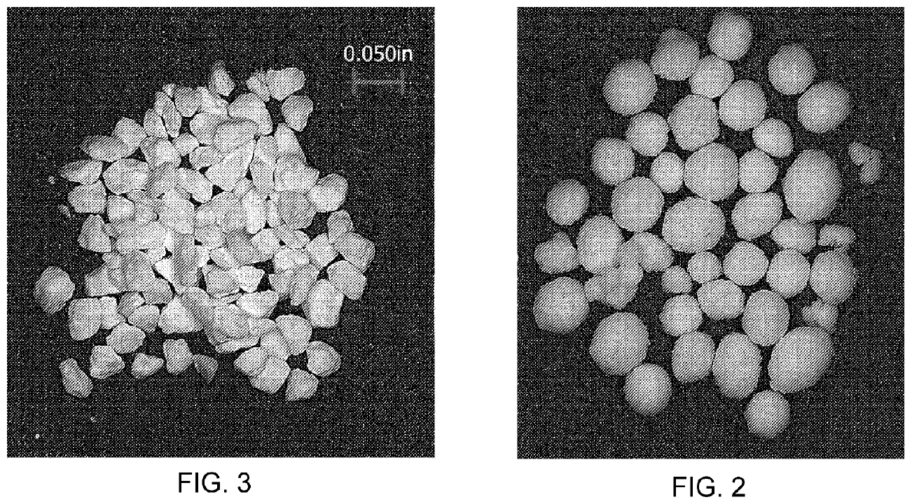

In exemplary embodiments, the particles including alumina (e.g., alpha alumina) may have a bead shape form, as shown in the photomicrograph of FIG. 2, for example. In the example of FIG. 2, the particles have a particle size between 0.7-2.0 mm. Each particle, on average, includes about >99.5% alpha alumina, with major trace elements of Na₂O, Fe₂O₃ and SiO₂. Each particle, on average, has a specific surface area in the range of 5 to 9 m²/g

In exemplary embodiments, the particles including alumina (e.g., alpha alumina) may have a granular shape, as shown in the photomicrograph of FIG. 3, for example. In the example of FIG. 3, the particles have a particle size of greater 1.5 mm. Each particle, on average, includes about >99.5% alpha alumina, with major trace elements of Na₂O, Fe₂O₃ and SiO₂. Each particle, on average, has a specific surface area in the range of 4 to 6 m²/g.

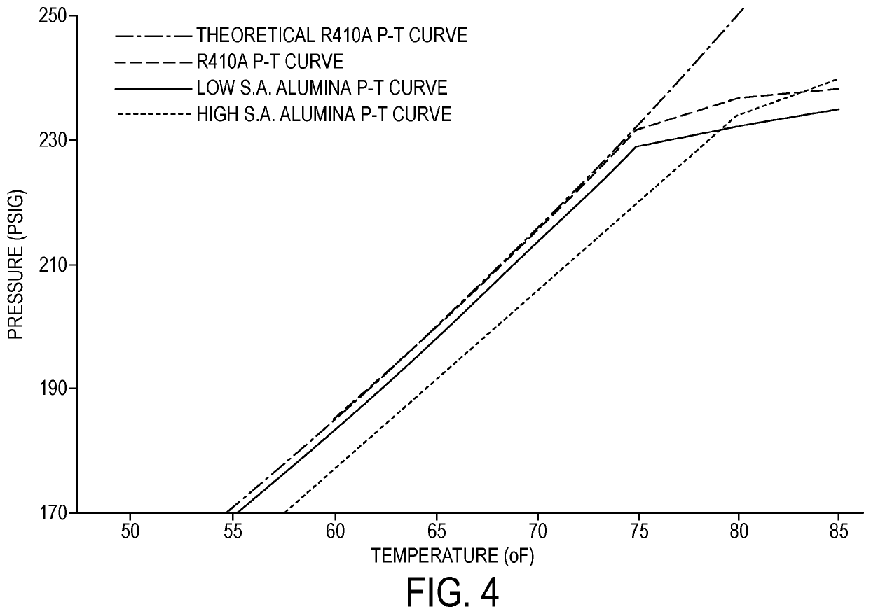

FIG. 4 is a chart of pressure (in psig) versus temperature (in Fahrenheit) showing comparative experimental test data of different ballast materials (“P-T curves”). The “Theoretical R410A” P-T curve shows a linear relationship between pressure and temperature, such that as temperature increases so does pressure. The “R410A” P-T curve shows experimental results without any ballast material, and which illustrates the actual deviation of the R410A refrigerant from the Theoretical R410A curve. As shown in this result, as the refrigerant temperature increases, the refrigerant expands. This data illustrates that when the R410A P-T curve bends and deviates from the Theoretical R410A curve, the refrigerant is transforming from liquid to gas. The “Low S.A. Alumina” P-T curve shows the results of a lower surface area alpha alumina material. A low surface area alumina material will generally have less pores and less adsorption of the refrigerant, and thus follows a similar trend as the R410A P-T curve, with the refrigerant becoming a gas at around 230 psi and 75° F. The “High S.A. Alumina” P-T curve shows the results of a higher surface area alpha alumina material. A higher surface area alumina material will generally have more adsorption of the refrigerant, so gas/liquid of the refrigerant may enter inside the particle. This then leads to the pressure of the refrigerant being more depressed compared to the Theoretical P-T curve, such that there is less pressure over the increased temperature range. The greater surface area also enables the refrigerant to remain in the liquid phase to higher temperatures, as evidenced by the bend in this P-T curve at about 235 psig and 80° F. In this manner, the greater the surface area of the alpha alumina ballast material provides greater adsorption of the refrigerant, and thus greater dampening characteristics.

In exemplary embodiments, the ballast material comprising alumina (e.g., alpha alumina) has a specific surface area in the range from 0.1 m²/g to 60 m²/g. More particularly, the ballast material comprising alumina (e.g., alpha alumina) may have a specific surface area in the range from 1 m²/g to 60 m²/g; more particularly from 10 m²/g to 60 m²/g; and more particularly from 20 m²/g to 60 m²/g. In some preferred non-limiting embodiments, the alumina (e.g., alpha alumina) ballast material may have a high specific surface area in the range from 40 m²/g to 60 m²/g, such as in the range from 45 m²/g to 60 m²/g, or from 45 m²/g to 55 m²/g, or from 50 m²/g to 60 m²/g. In some embodiments, the alumina (e.g., alpha alumina) ballast material may have a specific surface area of less than 60 m²/g, such as 55 m²/g or less, or as 50 m²/g or less, or 40 m²/g or less. In exemplary embodiments where the ballast material includes discrete particles of the alumina (e.g., alpha alumina), each discrete particle may have a specific surface area in the foregoing range(s), or the average specific area of the discrete particles may be in the foregoing range(s).

A thermal sensing bulb for an expansion valve has been described herein, in which the bulb contains a ballast material, the ballast material including alumina. In exemplary embodiments, the majority of the ballast material may include alumina, and more particularly may be alpha alumina, which may be in the form of a plurality of discrete particles. The alumina ballast material may have a desired surface area, pore size, particle size, particle shape, and/or particle size distribution for providing good manufacturing processability, hydrophobicity, heat-resistance, refrigerant compatibility, and desirable adsorption-desorption properties.

According to an aspect of the invention, a thermal sensing bulb for an expansion valve, the bulb containing a ballast material, the ballast material including alumina, such as alpha alumina.

Embodiments of the invention may include one or more of the following additional features, separately or in any combination.

In some embodiments, the ballast material comprises greater than 50% alumina, such as alpha alumina. In some embodiments, the ballast material comprises alumina (e.g., alpha) in the range of 60-100%. In some embodiments, the ballast material comprises alumina (e.g., alpha) in the range of 80-100%. In some embodiments, the ballast material comprises alumina (e.g., alpha) in the range of 90-100%. In some embodiments, the ballast material consists essentially of alumina, such as alpha alumina. For example, the ballast material may include 60%, 70%, 80%, 90%, 95%, 99%, or more alumina (e.g., alpha alumina), including all values, ranges and subranges between the stated values.

In some embodiments, the ballast material includes a plurality of discrete particles.

In some embodiments, each of the plurality of particles, or the plurality of particles on average, includes greater than 50% alumina (e.g., alpha); more particularly greater than 60% alumina (e.g., alpha); more particularly greater than 70% alumina (e.g., alpha); more particularly greater than 80% alumina (e.g., alpha); more particularly greater than 90% alumina (e.g., alpha); or more particularly each of the plurality of particles consists essentially of alumina (e.g., alpha). For example, each of the plurality of discrete particles, or the plurality of particles on average, may include 60%, 70%, 80%, 90%, 95%; 99%, or more alumina (e.g., alpha alumina), including all values, ranges and subranges between the stated values.

In some embodiments, the plurality of discrete particles constitutes greater than 50% of the ballast material contained in the bulb; more particularly greater than 60%; more particularly greater than 70%; more particularly greater than 80%; more particularly greater than 90%; or more particularly the plurality of discrete particles constitutes essentially all of the ballast material contained in the bulb. For example, the plurality of discrete particles may constitute 60%, 70%, 80%, 90%, 95%, 99%, or more of the ballast material contained in the bulb, including all values, ranges and subranges between the stated values.

In some embodiments, the plurality of discrete particles are in bead shaped form.

In some embodiments, the bead shaped particles have a particle size of between 0.7-2.0 mm.

In some embodiments, the plurality of discrete particles are in granular form.

In some embodiments, the granular particles have a particle size of greater than 1.5 mm.

In some embodiments, the plurality of discrete particles are substantially uniform in physical characteristic and a given quantity of the discrete particles exhibits a substantially uniform adsorption characteristic.

In some embodiments, the physical characteristic in which the particles are substantially uniform include one or more of size, shape, weight, surface area, porosity and density.

In some embodiments, the ballast material comprising alumina (e.g., alpha alumina) has a specific surface area in the range from 0.1 m²/g to 60 m²/g; more particularly 1 m²/g to 60 m²/g; more particularly 5 m²/g to 60 m²/g; more particularly 10 m²/g to 60 m²/g; more particularly 15 m²/g to 60 m²/g; more particularly 20 m²/g to 60 m²/g; more particularly 25 m²/g to 60 m²/g; more particularly 30 m²/g to 60 m²/g; more particularly 35 m²/g to 60 m²/g; more particularly 40 m²/g to 60 m²/g; or more particularly 45 m²/g to 60 m²/g; or more particularly 60 m²/g or less, and equal to or greater than the lower bound(s) of the aforementioned ranges. In some embodiments, the alumina (e.g., alpha alumina) ballast material may have a specific surface area of less than 60 m²/g, such as 55 m²/g or less, or as 50 m²/g or less, or 40 m²/g or less. By way of non-limiting example, the alumina (e.g., alpha alumina) ballast material may have a specific surface area of 1 m²/g, 5 m²/g, 10 m²/g, 15 m²/g, 20 m²/g, 25 m²/g, 30 m²/g, 35 m²/g, 40 m²/g, 45 m²/g, 50 m²/g, 55 m²/g, or 60 m²/g, including all values, ranges and subranges between the stated values. In exemplary embodiments where the ballast material includes discrete particles of the alumina (e.g., alpha alumina), each discrete particle may have a specific surface area in the foregoing range(s), or the average specific area of the discrete particles may be in the foregoing range(s) or have the foregoing specific value(s).

According to another aspect of the invention, a thermal sensing bulb for an expansion valve is provided, the bulb containing a ballast material, the ballast material including alumina having a specific surface area in the range of 1-50 m²/g.

In some embodiments, the alumina is alpha alumina or another form of alumina, such as gamma or theta alumina.

In some embodiments, the alumina has a specific surface area in the range of 5 m²/g to 60 m²/g; more particularly 10 m²/g to 60 m²/g; more particularly 15 m²/g to 60 m²/g; more particularly 20 m²/g to 60 m²/g; more particularly 25 m²/g to 60 m²/g; more particularly 30 m²/g to 60 m²/g; more particularly 35 m²/g to 60 m²/g; more particularly 40 m²/g to 60 m²/g; or more particularly 45 m²/g to 60 m²/g; or more particularly 50 m²/g or less, and equal to or greater than the lower bound(s) of the aforementioned ranges. For example, the alumina ballast material may have a specific surface area of 5 m²/g, 10 m²/g, 15 m²/g, 20 m²/g, 25 m²/g, 30 m²/g, 35 m²/g, 40 m²/g, 45 m²/g, 50 m²/g, 55 m²/g, or 60 m²/g, including all values, ranges and subranges between the stated values.

In some embodiments where the ballast material includes discrete particles of the alumina, each discrete particle may have a specific surface area in the foregoing range(s), or the average specific area of all of the discrete particles may be in the foregoing range(s) or have the foregoing specific value(s).

According to another aspect of the invention, a refrigerant system includes: a thermostatic expansion valve, said expansion valve comprising a thermal sensing bulb, said thermal sensing bulb comprising a working fluid, said working fluid sealed inside said thermal sensing bulb and in operative communication with said expansion valve; and a ballast comprising alumina according to any of the foregoing in said thermal sensing bulb.

It is to be understood that all ranges and ratio limits disclosed in the specification and claims may be combined in any manner, including all values and subranges between the stated values. It is also understood that the term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or ±0.0% of the stated value, as well as values intervening such stated values, unless explicitly stated otherwise.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A thermal sensing bulb for an expansion valve, the bulb containing a ballast material, the ballast material comprising alpha alumina.

2. The thermal sensing bulb according to claim 1, wherein the ballast material comprises greater than 50% alpha alumina.

3. The thermal sensing bulb according to claim 1, wherein the ballast material comprises alpha alumina in the range of 60-100%.

4. The thermal sensing bulb according to claim 1, wherein the ballast material comprises alpha alumina in the range of 80-100%.

5. The thermal sensing bulb according to claim 1, wherein the ballast material comprises alpha alumina in the range of 90-100%.

6. The thermal sensing bulb according to claim 1, wherein the ballast material consists essentially of alpha alumina.

7. The thermal sensing bulb according to claim 1, wherein the ballast material includes a plurality of discrete particles.

8. The thermal sensing bulb according to claim 7, wherein each of the plurality of particles includes greater than 50% alpha alumina.

9. The thermal sensing bulb according to claim 7, wherein the plurality of discrete particles constitutes greater than 50% of the ballast material contained in the bulb.

10. The thermal sensing bulb according to claim 7, wherein the plurality of discrete particles are in bead shaped form.

11. The thermal sensing bulb according to claim 10, wherein the bead shaped particles have a particle size of between 0.7-2.0 mm.

12. The thermal sensing bulb according to claim 7, wherein the plurality of discrete particles are in granular form.

13. The thermal sensing bulb according to claim 12, wherein the granular particles have a particle size of greater than 1.5 mm.

14. The thermal sensing bulb according to claim 7, wherein the plurality of discrete particles are substantially uniform in physical characteristic and a given quantity of the discrete particles exhibits a substantially uniform adsorption characteristic.

15. The thermal sensing bulb according to claim 14, wherein the physical characteristic in which the particles are substantially uniform include one or more of size, shape, weight, surface area, porosity and density.

16. The thermal sensing bulb according to claim 1, wherein the ballast material comprising alpha alumina has a specific surface area in the range from 0.1 m²/g to 50 m²/g.

17. A thermal sensing bulb for an expansion valve, the bulb containing a ballast material, the ballast material comprising alumina having a specific surface area in the range of 1-50 m²/g.

18. The thermal sensing bulb according to claim 17, wherein the alumina has a specific surface area in the range of 5 m²/g to 50 m²/g.

19. A refrigeration system comprising:
a thermostatic expansion valve, said expansion valve comprising a thermal sensing bulb, said thermal sensing bulb comprising a working fluid, said working fluid sealed inside said thermal sensing bulb and in operative communication with said expansion valve; and
a ballast according to claim 1 in said thermal sensing bulb.

20. A thermal sensing bulb for an expansion valve, the thermal sensing bulb containing an alpha alumina ballast material having an exterior surface with porosity configured to adsorb and desorb refrigerant in the bulb and having a specific surface area in the range of 1-50 m²/g.
